(19) United States
(12) Patent Application Publication
(10) Pub. No.: US 2005/0126361 A1
(43) Pub. Date: Jun. 16, 2005

(54) Motorized wood working tool having a low friction table

(75) Inventors: Dan B. Nelson, Anderson, SC (US); Brian D. Mertel, Simpsonville, SC (US)

Correspondence Address: BROOKS KUSHMAN P.C., 1000 TOWN CENTER, TWENTY-SECOND FLOOR, SOUTHFIELD, MI, 48075, US

(73) Assignee: One World Technologies Limited, Hamilton (BM)

(21) Appl. No.: 10/736,249

(22) Filed: Dec. 15, 2003

(51) Int. Cl. B26D 7/06; B26D 1/00

(52) U.S. Cl. 83/401

(57) ABSTRACT

A motorized woodworking tool is provided having a base with a metal top having a generally planar workpiece support surface. A low resistance surface layer is applied directly to the workpiece support surface to provide a low friction, highly durable surface for cooperating with a workpiece placed thereon for sliding contact with the surface layer during the cutting operation.

### BACKGROUND OF THE INVENTION

1. Field of the Invention

The present invention relates to motorized woodworking tools having a low friction surface for supporting a workpiece to be cut.

2. Background Art

Motorized wood working tools, both floor mounted or bench types are frequently provided with a generally horizontal table surface to support a wooden work piece to be cut. Representative tools having a planar table top include scroll saws, table saws, band saws, surface planers, joiner planers, belt sanders, disc sanders, router tables, jig saw base plates and miter saw tables. Common to all of these motorized wood working tools is the presence of a generally flat horizontal table top which the user supports a workpiece to be cut by a motor driven cutting element such as a saw blade. Frequently, particularly when making a precise free hand cut using a scroll saw or a band saw, it is highly desirable to minimize the friction between the workpiece and the table top so that the pattern marked on the workpiece can be closely followed. On circular table saws where cutting normally takes place using a fence, it is still desirable to minimize friction between the workpiece and the table so that the workpiece can be smoothly fed relative to the cutting element at a constant speed without sticking and bonding.

Traditionally, the table top of a motorized woodworking floor mounted or bench top tool would be a metal plate having a generally flat planar surface which is then machined flat when used in the “as machined” state. In the case of scroll saws and small light duty band saws, the table top will be frequently formed of an aluminum die casting. In such instances, the table top is machined flat and often coated with a clear finish in order to prevent corrosion and staining. Even with this clear coat applied to the machine table top, friction levels between the workpiece and the table top are higher than desired.

### SUMMARY OF THE INVENTION

Accordingly, the motorized woodworking tool of the present invention is provided with a base having a metal table top having a generally planar workpiece support surface with an opening formed therein. The tool further includes a motor which drives a cutting element oriented to extend through the opening in the workpiece support surface. A surface layer is applied directly to the workpiece support surface of the metal table top to create a low friction surface for cooperating with a workpiece placed thereon for sliding contact relative to the surface layer during cutting. The invention is suitable for use with scroll saws, table saws and band saws where the workpiece is slid across the support surface relative to the cutting blade during use. Preferably, the metal table top is formed of cast iron, die cast aluminum or cast aluminum.

### BRIEF DESCRIPTION OF THE DRAWINGS

FIG. 1 is a perspective view of a motorized woodworking tool having a low friction table top in accordance with the present invention;

FIG. 2 is a cross-sectional view of a wing of the planar workpiece support surface of FIG. 1 along line 2-2 having a low friction surface layer applied thereon;

FIG. 3 is a scroll saw having a low friction table top in accordance with another aspect of the present invention; and

FIG. 4 is a band saw having a low friction table top in accordance with yet another aspect of the present invention.

### DETAILED DESCRIPTION OF THE PREFERRED EMBODIMENT(S)

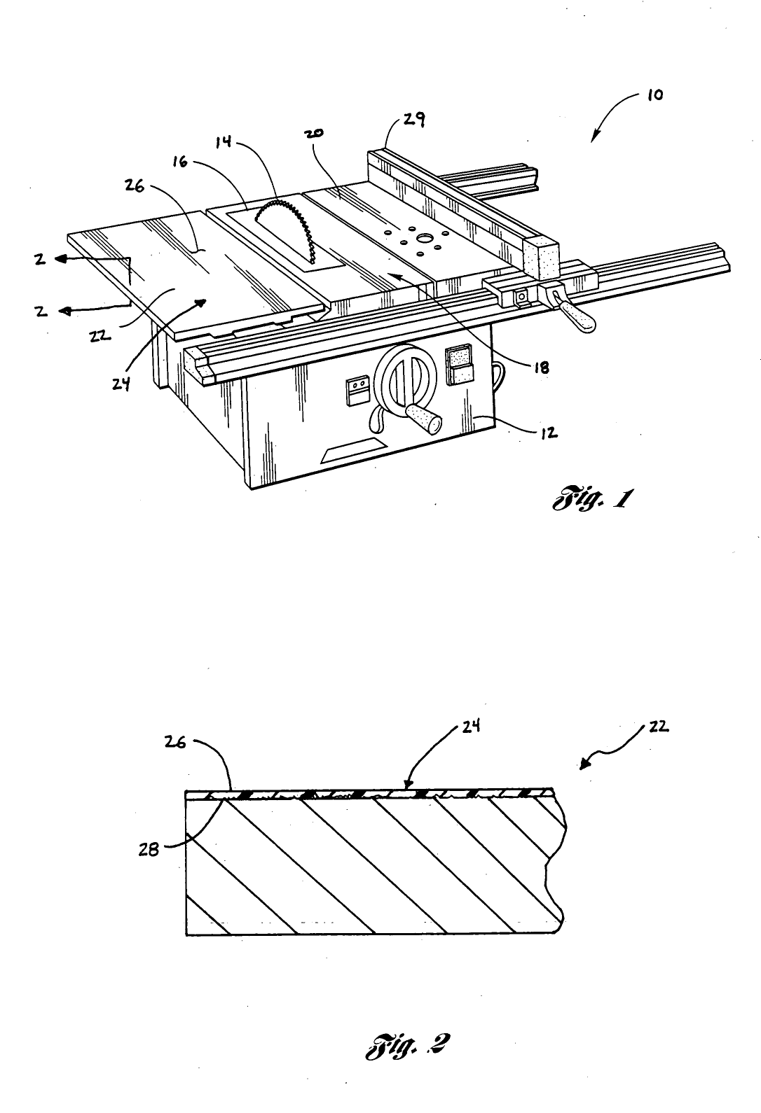

Referring now to Figures, a motorized woodworking tool having a low friction table for supporting a workpiece during a cutting operation is shown. FIGS. 1 and 2 illustrate a table saw 10 providing a first embodiment of the claimed invention. Table saw 10 is provided with a base 12 having a motor (not shown) located internally thereto which drives a circular rotary cutting blade 14. Blade 14 extends through a slot 16 in a metal table top 18.

A pair of generally planar table wings 20 and 22 which likewise have a flat, generally planar surface are provided coplanar to the metal table top 18, forming a generally flat planar workpiece support surface 24. Table top 18 and wings 20, 22 are formed from a cast metal such as die cast aluminum, cast iron or the like. Referring additionally to FIG. 2, a surface layer 26 is applied to the top surface 28 of at least one of wings 20, 22 and table top 18. Surface layer 26 preferably comprises a plastic laminate, such as Formica, which provides a uniform, low friction, highly durable surface cooperating with a workpiece placed thereon to be cut by a user with the rotary cutting blade 14. It is understood that the each wing 20, 22 and the table top 18 may be covered with a plastic laminate surface layer 26 to reduce friction between the planar workpiece support surface 24 and the workpiece.

In one aspect of the invention, the surface layer 26 is bonded to the unfinished top surface 28 of each wing 20, 22 of the table saw 10, reducing the overall production costs. Alternatively, the top surface 28 of wing 22 may be machined flat similar to table top 18 prior to the application of the surface layer 26 to improve the bonding characteristics between the surface layer 26 and wing 22. Surface layer 26 is relatively is thin, between 1/32 and 1/16 inch in thickness, and is supported by the top surface 28 of wing 22.

Plastic laminates are firm, highly resistant to scratching and easy to clean after use. The plastic laminate surface layer 26 of workpiece support surface 20 exhibits low, friction, non-stick characteristics, enabling the workpiece to be freely moved relative to the cutting blade 14. If desired, a plastic laminate surface layer may be applied to the movable fence 29 to provide a low friction surface for engaging a workpiece to be cut on the table saw 10.

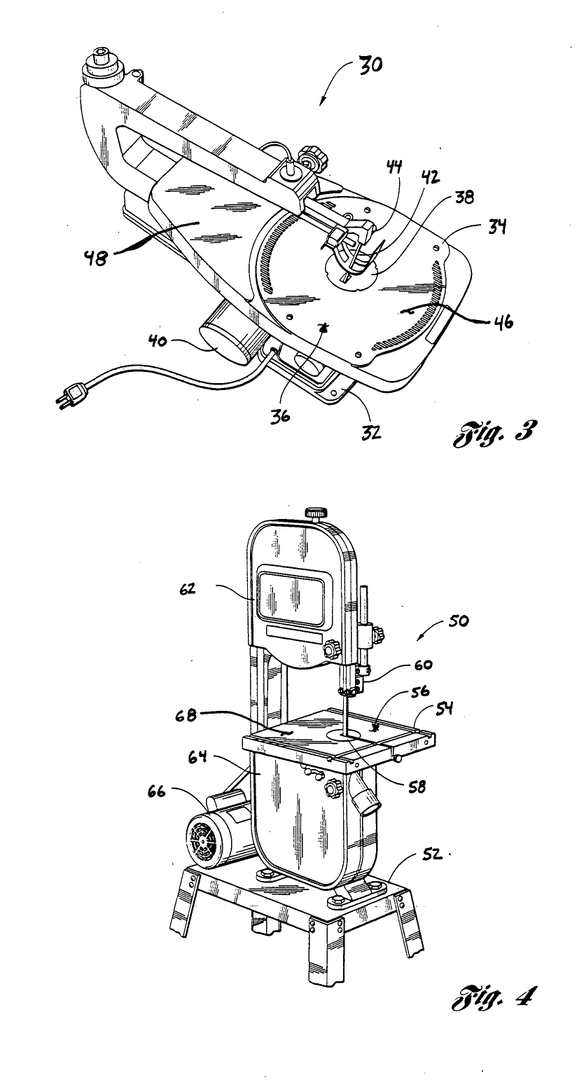

FIG. 3 illustrates a scroll saw 30 illustrating another aspect of the claimed invention. Scroll saw 30 is provided with a base 32 having a metal table top 34 pivotally mounted thereto in a conventional manner. Metal table top 34 is provided with a generally planar work support surface 36 having an opening 38 extending therethrough. A motor 40 is attached to base 32 and operatively connected to a saw blade 42 which is affixed to a pair of blade holders; upper blade holder 44 and a similar blade holder not shown located below the underside of the table top 34 in a conventional manner. During operation, motor 40 causes elongate blade 42 to oscillate vertically relative a workpiece placed on the planar workpiece support surface 36 to be slid relative to the blade during cutting.

Workpiece support surface 36 includes a surface layer 46 applied to the metal table top 34. As described above, surface layer 46 is preferably a plastic laminate, such as formica, which exhibits low, friction, non-stick characteristics, enabling the workpiece to be freely moved relative to the saw blade 42. It is also understood that the extension table 48 of scroll saw 30 may be covered with a plastic laminate surface layer in accordance with the present invention.

Another aspect of the motorized woodworking tool of the present invention is illustrated in FIG. 4. A band saw 50 is provided with a base 52 having a tiltable metal table top 54 with a generally planar work support surface 56. The table top 54 is further provided with an aperture 58 extending therethrough to receive band saw blade 60. Band saw blade 60 is a traditional, endless loop type blade which is entrained about a pair of wheels 62 and 64 shown in phantom outline above and below the metal table top 54 as illustrated.

Motor 66 is operatively connected to one of the wheels, preferably, lower wheel 64, to cause the blade to move in an oval path with the exposed portion of the blade above metal table top 54, moving downward toward the planar workpiece support surface 56. As in the other described aspects of the invention, planar workpiece support surface 56 includes a plastic laminate surface layer 68 applied to the metal table top 54 to reduce friction between the workpiece and the surface layer 68 to be freely moved relative to the saw blade 60.

While embodiments of the invention have been illustrated and described, it is not intended that these embodiments illustrate and describe all possible forms of the invention, for example the invention can be used with scroll saws, table saws, band saws, surface planers, joiner planers, belt sanders, disc sanders, router tables, jig saw base plates and miter saw tables. Rather, the words used in the specification are words of description rather than limitation, and it is understood that various changes may be made without departing from the spirit and scope of the invention.

1. A motorized wood working tool comprising:
a base provided with a metal table top having a generally planar workpiece support surface with an opening formed therein;
a motor; and
a cutting element driven by the motor and oriented to extend through the opening in the workpiece support surface of the table top,
wherein a surface layer is applied directly to the workpiece support surface of the metal table to create a low friction surface for cooperating with a workpiece placed thereon for sliding contact relative to the surface layer during cutting.

2. The motorized wood working tool of claim 1 wherein the tool comprises a circular table saw.

3. The motorized wood working tool of claim 1 wherein the tool comprises a scroll saw.

4. The motorized wood working tool of claim 1 wherein the tool comprises a band saw.

5. The motorized wood working tool of claim 1 wherein the metal table top is formed of a metal casting to which the surface layer is applied.

6. The motorized wood working tool of claim 5 wherein the metal casting of the metal table top comprises cast iron.

7. The motorized wood working tool of claim 5 wherein the metal casting of the metal table top comprises an aluminum die casting.

8. The motorized wood working tool of claim 1 wherein the surface layer applied to the workpiece support surface is a plastic laminate.

9. The motorized wood working tool of claim 8 wherein the plastic laminate comprises formica.

10. A table saw comprising:
a base provided with a cast metal table top and a general planar work support surface with an opening formed therethrough;
a motor; and
a circular saw blade operatively driven by the motor in a rotary fashion, the saw blade extending through the opening formed in the generally planar work support surface to cut a workpiece placed thereon and moved relative to the circular saw blade,
wherein a plastic laminate is applied directly to the workpiece support surface of the cast metal table top to create a low friction surface for cooperating with a workpiece placed thereon for sliding contact relative to the plastic laminate during cutting.

11. The table saw of claim 10 wherein the cast metal table top comprises a cast iron table top to which the plastic laminate is applied.

12. The table saw of claim 10 wherein the plastic laminate comprises formica.

13. A scroll saw comprising:
a base provided with a cast metal table top having a generally planar work support surface with an opening formed therethrough;
a motor; and
a pair of spaced apart blade holders for supporting a blade therebetween, operatively driven by the motor in a reciprocal manner or wherein a blade spanning between the blade holders passes through the opening in the table top;
wherein a plastic laminate is applied directly to the workpiece support surface of the cast metal table top to create a low friction surface for cooperating with a workpiece placed thereon for sliding contact relative to the plastic laminate during cutting.

14. The scroll saw of claim 13 wherein the cast metal table top comprises a die cast aluminum table top to which the plastic laminate is applied.

15. The scroll saw of claim 13 wherein the plastic laminate comprises formica.

16. A band saw comprising;
a base provided with a metal tabletop having a generally planer workpiece support surface with an opening formed therein;
a motor;
a pair of wheels lying in a common plane, one positioned above and one positioned below the table top wherein one of the wheels is operatively driven by the motor; and
an endless loop cutting blade entrained about the wheels and passing through the opening in the table top;
wherein a plastic laminate is applied directly to the workpiece support surface of the cast metal table top to create a low friction surface for cooperating with a workpiece placed thereon for sliding contact relative to the plastic laminate during cutting.

17. The band saw of claim 16 wherein the cast metal table top comprises a die cast aluminum table top to which the plastic laminate is applied.

18. The band saw of claim 16 wherein the plastic laminate comprises formica.
